(19) United States
(12) Patent Application Publication
(10) Pub. No.: US 2026/0332036 A1
(43) Pub. Date: Oct. 22, 2026

(54) THREE-PHASE AC-DC BIDIRECTIONAL CONVERSION CIRCUIT

(71) Applicant: SHENZHEN DEEPPOWER TECHNOLOGY ENERGY CO., LTD., Shenzhen, Guangdong (CN)

(72) Inventors: Xiaolu Xiang, Shenzhen, Guangdong (CN); Junmin Li, Shenzhen, Guangdong (CN)

(21) Appl. No.: 19/109,581

(22) PCT Filed: Jun. 30, 2023
(86) PCT No.: PCT/CN2023/104843

§ 371 Date: Mar. 7, 2025

(30) Foreign Application Priority Data
Sep. 9, 2022 (CN) 202211104497.2

(51) Int. Cl. H02M 1/14; H02M 1/00; H02M 1/04; H02M 1/44; H02M 7/793

(52) U.S. Cl. CPC H02M 1/146; H02M 1/0043; H02M 1/045; H02M 1/44; H02M 7/793

(57) ABSTRACT

Disclosed is a three-phase AC-DC bidirectional conversion circuit. The circuit comprises three boost circuits and one output capacitor circuit, wherein each boost circuit comprises an inductor circuit and a switch circuit, the inductor circuit comprises a first inductor and a self-coupling inductor, the switch circuit comprises eight switch tubes and four diodes. The three boost circuits employ three-phase interleaving technology, with the three-phase input and output currents differing by 120°. The input and output current fluctuations of the three-phase boost circuits are complementary, resulting in small input and output voltage and current ripples in the three-phase AC-DC bidirectional conversion circuit, thereby achieving excellent circuit performance. Additionally, each boost circuit is equipped with a first inductor and a self-coupling inductor. Through interleaved paralleling, the switching frequency can be increased, enabling low-cost filtering and reducing control complexity. At the same time, it can further reduce input and output voltage and current ripples.

This application is based on and claims the priority of Chinese patent application No. 202211104497.2 filed on Sep. 9, 2022, the entire contents of which are hereby incorporated into this application as a whole.

### TECHNICAL FIELD

The present application relates to the technical field of power conversion, in particular to a three-phase AC-DC bidirectional conversion circuit.

### BACKGROUND ART

The AC-DC bidirectional conversion circuit is a circuit that allows mutual conversion between industrial frequency AC and DC, making the power conversion system simpler and more efficient. With the rapid development of the new energy industry, AC-DC bidirectional conversion circuits are widely used in various new energy power electronic devices such as photovoltaic energy storage and APF. Especially in recent years, as photovoltaic power, wind power, integrated charging and storage solutions merge with energy storage and trend towards higher power, the demand for high-power three-phase AC-DC converters has been increasing, and their applications have become more widespread. However, the current industry still employs traditional T-type or I-type three-level technology for AC-DC bidirectional conversion. Due to industry habits and limitations of high-voltage semiconductors, switching frequencies rarely exceed 20 kHz. This poses numerous challenges in terms of power inductors and EMC filtering, such as large volume, high cost, and difficult filtering. Especially when inverting a three-level signal into a standard sine wave, the industry commonly adopts LCL filters for cost-effective filtering. However, the secondary resonance of LCL filters can easily cause control loop oscillation, particularly in multi-machine paralleling systems, where the impact of secondary resonance is more pronounced and oscillations are more likely to occur, further complicating loop control.

### SUMMARY OF THE INVENTION

The technical problem addressed by the present application is to provide a three-phase AC-DC bidirectional conversion circuit that can increase switching frequency, achieve low-cost filtering, reduce input and output voltage and current ripples, and decrease control complexity.

To solve the above technical problem, the present application provides a three-phase AC-DC bidirectional conversion circuit. The circuit includes three boost circuits with the same structure and one output capacitor circuit, wherein each boost circuit includes an inductor circuit and a switch circuit, the inductor circuit includes a first inductor and a self-coupling inductor, the switch circuit includes eight switch tubes and four diodes, every four switch tubes are connected in series to form a bridge arm, two bridge arms are connected in parallel and are then connected to one side of the output capacitor circuit, every two diodes are connected in series and are then connected in parallel to two switch tubes located in the middle of a bridge arm, a junction between the two diodes connected in series is connected to the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to midpoints of the bridge arms, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

Further, the output capacitor circuit includes a fourth capacitor and a fifth capacitor, the fourth capacitor and the fifth capacitor are connected in series and then connected in parallel with the bridge arms of the three boost circuits, and a junction of the fourth capacitor and the fifth capacitor is a midpoint of the output capacitor circuit and is connected to the junction between two diodes connected in series.

Further, the three-phase AC-DC bidirectional conversion circuit further includes an EMI filter circuit, the EMI filter circuit includes a first capacitor, a second capacitor and a third capacitor, and the first capacitor, the second capacitor and the third capacitor are connected in parallel between the first external side of the three-phase AC-DC bidirectional conversion circuit and the midpoint of the output capacitor circuit.

Further, the switch tube is selected from MOSFET, IGBT, GaN tube or SiC power tube.

To solve the above technical problem, the present application further provides a three-phase AC-DC bidirectional conversion circuit. The circuit includes three boost circuits with the same structure and one output capacitor circuit, wherein each boost circuit includes an inductor circuit and a switch circuit, the inductor circuit includes a first inductor and a self-coupling inductor, the switch circuit includes four switch tubes, a first bidirectional switch and a second bidirectional switch, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to the first bidirectional switch and the second bidirectional switch, the other ends of the first bidirectional switch and the second bidirectional switch are both connected to the output capacitor circuit, midpoints of the two bridge arms are respectively connected to a connection node between the self-coupling inductor and the first bidirectional switch and a connection node between the self-coupling inductor and the second bidirectional switch, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

To solve the above technical problem, the present application further provides a three-phase AC-DC bidirectional conversion circuit. The circuit includes three boost circuits with the same structure and one output capacitor circuit, wherein each boost circuit includes an inductor circuit and a switch circuit, the inductor circuit includes a first inductor and a self-coupling inductor, the switch circuit includes four switch tubes, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to midpoints of the bridge arms, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

Further, the output capacitor circuit includes a sixth capacitor, and the sixth capacitor is connected in parallel with the bridge arms of the three boost circuits.

Compared to the prior art, the switch tube of the boost circuit in the three-phase AC-DC bidirectional conversion circuit provided by the present application can achieve bidirectional energy flow. The three boost circuits employ three-phase interleaving technology, with the three-phase input and output currents differing by 120°. The input and output current fluctuations of the three-phase boost circuits are complementary, resulting in small input and output voltage and current ripples in the three-phase AC-DC bidirectional conversion circuit, thereby achieving excellent circuit performance. Additionally, each boost circuit is equipped with a first inductor and a self-coupling inductor. Through interleaved paralleling, the switching frequency can be increased, enabling low-cost filtering and reducing control complexity. At the same time, it can further reduce input and output voltage and current ripples. Additionally, the interleaved design of each boost circuit enables the two branches containing the self-coupling inductors to achieve current sharing during both forward and reverse energy flow, preventing uneven heating of branch components and ensuring normal operation of the circuit.

### BRIEF DESCRIPTION OF THE DRAWINGS

FIG. 1 is a circuit diagram of a first embodiment of a three-phase AC-DC bidirectional conversion circuit provided by the present application.

FIG. 2 is a circuit diagram of a second embodiment of a three-phase AC-DC bidirectional conversion circuit provided by the present application.

FIG. 3 is a circuit diagram of a third embodiment of a three-phase AC-DC bidirectional conversion circuit provided by the present application.

### DETAILED DESCRIPTION OF THE INVENTION

In order to make those of ordinary skill in the art more clearly understand the purpose, technical scheme and advantages of the present application, the present application will be further elaborated with the attached drawings and embodiments.

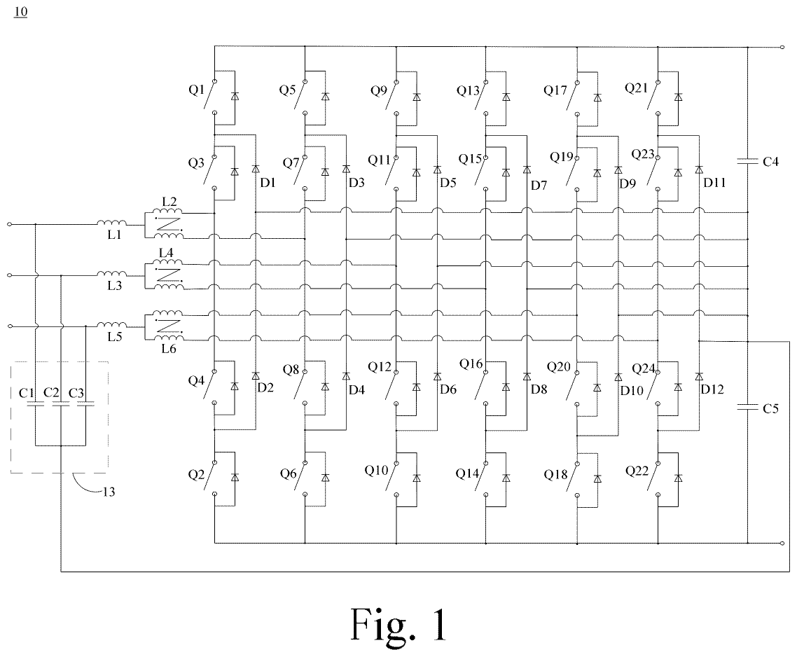

Refer to FIG. 1, which is a circuit diagram of a first embodiment of a three-phase AC-DC bidirectional conversion circuit 10 provided by the present application. In the embodiment shown in this figure, the three-phase AC-DC bidirectional conversion circuit 10 includes three boost circuits with the same structure and one output capacitor circuit, wherein each boost circuit includes an inductor circuit and a switch circuit, the inductor circuit includes a first inductor and a self-coupling inductor, the switch circuit includes eight switch tubes and four diodes, every four switch tubes are connected in series to form a bridge arm, two bridge arms are connected in parallel and are then connected to one side of the output capacitor circuit, every two diodes are connected in series and are then connected in parallel to two switch tubes located in the middle of a bridge arm, a junction between the two diodes connected in series is connected to the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to midpoints of the bridge arms, the other side of the output capacitor circuit serves as a second external side of the three-phase AC-DC bidirectional conversion circuit 10, and the other end of each first inductor in each of the three boost circuits serves as a first external side of the three-phase AC-DC bidirectional conversion circuit 10. It is understandable that both the first external side and the second external side of the three-phase AC-DC bidirectional conversion circuit 10 can be connected to loads and AC power sources. When the first external side serves as an AC side, it can be connected to an AC power source, and the second external side acts as a DC output side, which can be connected to a load. Conversely, when the second external side serves as the AC side, it can be connected to an AC power source, while the first external side acts as the DC output side, which can be connected to a load. Based on the above design, each boost circuit is equipped with a first inductor and a self-coupling inductor. Through interleaved paralleling, the switching frequency can be increased, enabling low-cost filtering and reducing control complexity. At the same time, it can lower stress and reduce input and output voltage and current ripples. The three boost circuits employ three-phase interleaving technology, with the three-phase input and output currents differing by 120°. The input and output current fluctuations of the three-phase boost circuits are complementary, resulting in small input and output current ripples in the three-phase AC-DC bidirectional conversion circuit 10. Additionally, the interleaved design enables the two branches containing the self-coupling inductors to achieve current sharing during both forward and reverse energy flow. This prevents uneven heating of branch components and avoids triggering overcurrent protection due to uneven branch currents, allowing the circuit to operate normally and thereby improving circuit performance.

Specifically, in this embodiment, the three boost circuits with the same structure are referred to as a first boost circuit, a second boost circuit, and a third boost circuit. The inductor circuit in the first boost circuit includes a first inductor L1 and a self-coupling inductor L2. The switch circuit of the first boost circuit includes a first switch tube Q1, a second switch tube Q2, a third switch tube Q3, a fourth switch tube Q4, a fifth switch tube Q5, a sixth switch tube Q6, a seventh switch tube Q7, and an eighth switch tube Q8, along with a first diode D1, a second diode D2, a third diode D3, and a fourth diode D4. A midpoint of a bridge arm formed by the series connection of the first switch tube Q1, the second switch tube Q2, the third switch tube Q3, and the fourth switch tube Q4 is connected to a non-dotted terminal of a primary winding of the self-coupling inductor L2, with the third switch tube Q3 and the fourth switch tube Q4 located in the middle of the bridge arm. The first diode D1 and the second diode D2 are connected in series, and then connected in parallel to the series-connected third switch tube Q3 and fourth switch tube Q4. A junction between the first diode D1 and the second diode D2 is connected to the output capacitor circuit, meaning an anode of the first diode D1 and a cathode of the second diode D2 are both connected to the output capacitor circuit after being connected together. A midpoint of a bridge arm formed by the series connection of the fifth switch tube Q5, the sixth switch tube Q6, the seventh switch tube Q7, and the eighth switch tube Q8 is connected to a dotted terminal of a secondary winding of the self-coupling inductor L2, with the seventh switch tube Q7 and the eighth switch tube Q8 located in the middle of the bridge arm. The third diode D3 and the fourth diode D4 are connected in series, and then connected in parallel to the series-connected seventh switch tube Q7 and eighth switch tube Q8. A junction between the third diode D3 and the fourth diode D4 is connected to the output capacitor circuit, meaning an anode of the third diode D3 and a cathode of the fourth diode D4 are both connected to the output capacitor circuit after being connected together.

The inductor circuit in the second boost circuit includes a first inductor L3 and a self-coupling inductor LA. The switch circuit of the second boost circuit includes a ninth switch tube Q9, a tenth switch tube Q10, an eleventh switch tube Q11, a twelfth switch tube Q12, a thirteenth switch tube Q13, a fourteenth switch tube Q14, a fifteenth switch tube Q15 and a sixteenth switch tube Q16, along with a fifth diode D5, a sixth diode D6, a seventh diode D7, and an eighth diode D8. A midpoint of a bridge arm formed by the series connection of the ninth switch tube Q9, the tenth switch tube Q10, the eleventh switch tube Q11, and the twelfth switch tube Q12 is connected to a non-dotted terminal of a primary winding of the self-coupling inductor L4, with the eleventh switch tube Q11 and the twelfth switch tube Q12 located in the middle of the bridge arm. The fifth diode D5 and the sixth diode D6 are connected in series, and then connected in parallel to the series-connected eleventh switch tube Q11 and twelfth switch tube Q12. A junction between the fifth diode D5 and the sixth diode D6 is connected to the output capacitor circuit, meaning an anode of the fifth diode D5 and a cathode of the sixth diode D6 are both connected to the output capacitor circuit after being connected together. A midpoint of a bridge arm formed by the series connection of the thirteenth switch tube Q13, the fourteenth switch tube Q14, the fifteenth switch tube Q15 and the sixteenth switch tube Q16 is connected to a dotted terminal of a secondary winding of the self-coupling inductor L4, with the fifteenth switch tube Q15 and the sixteenth switch tube Q16 located in the middle of the bridge arm. The seventh diode D7 and the eighth diode D8 are connected in series, and then connected in parallel to the series-connected fifteenth switch tube Q15 and sixteenth switch tube Q16. A junction between the seventh diode D7 and the eighth diode D8 is connected to the output capacitor circuit, meaning an anode of the seventh diode D7 and a cathode of the eighth diode D8 are both connected to the output capacitor circuit after being connected together.

The inductor circuit in the third boost circuit includes a first inductor L5 and a self-coupling inductor L6. The switch circuit of the third boost circuit includes a seventeenth switch tube Q17, an eighteenth switch tube Q18, a nineteenth switch tube Q19, a twentieth switch tube Q20, a twenty-first switch tube Q21, a twenty-second switch tube Q22, a twenty-third switch tube Q23 and a twenty-fourth switch tube Q24, along with a ninth diode D9, a tenth diode D10, an eleventh diode D11, and a twelfth diode D12. A midpoint of a bridge arm formed by the series connection of the seventeenth switch tube Q17, the eighteenth switch tube Q18, the nineteenth switch tube Q19, and the twentieth switch tube Q20 is connected to a non-dotted terminal of a primary winding of the self-coupling inductor L6, with the nineteenth switch tube Q19 and the twentieth switch tube Q20 located in the middle of the bridge arm. The ninth diode D9 and the tenth diode D10 are connected in series, and then connected in parallel to the series-connected nineteenth switch tube Q19 and twentieth switch tube Q20. A junction between the ninth diode D9 and the tenth diode D10 is connected to the output capacitor circuit, meaning an anode of the ninth diode D9 and a cathode of the tenth diode D10 are both connected to the output capacitor circuit after being connected together. A midpoint of a bridge arm formed by the series connection of the twenty-first switch tube Q21, the twenty-second switch tube Q22, the twenty-third switch tube Q23, and the twenty-fourth switch tube Q24 is connected to a dotted terminal of a secondary winding of the self-coupling inductor L4, with the twenty-third switch tube Q23 and the twenty-fourth switch tube Q24 located in the middle of the bridge arm. The eleventh diode D11 and the twelfth diode D12 are connected in series, and then connected in parallel to the series-connected twenty-third switch tube Q23 and twenty-fourth switch tube Q24. A junction between the eleventh diode D11 and the twelfth diode D12 is connected to the output capacitor circuit, meaning an anode of the eleventh diode D11 and a cathode of the twelfth diode D12 are both connected to the output capacitor circuit after being connected together.

Preferably, the switch tube is selected from MOS, IGBT, GaN tube, SiC power tube, or other controllable power switch tubes to achieve better circuit performance. In this embodiment, diodes are also paralleled with the switch tubes. If the switch tube is a MOS transistor, a diode is connected in parallel between its drain and source. If the switch tube is an IGBT, a diode is connected in parallel between its emitter and collector. Further, this embodiment employs a PFM method to control the operation of the switch tube, using a constant duty cycle with fixed on and off times for the switch tube. Regulation is achieved by modulating the square wave frequency, allowing for zero-current startup of the three-phase AC-DC bidirectional conversion circuit 10 in low-frequency operating modes.

In some embodiments, the output capacitor circuit includes a fourth capacitor C4 and a fifth capacitor C5, the fourth capacitor C4 and the fifth capacitor C5 are connected in series and then connected in parallel with the bridge arms of the three boost circuits, and a junction of the fourth capacitor C4 and the fifth capacitor C5 is a midpoint of the output capacitor circuit and is connected to junctions between the series-connected first diode D1 and second diode D2, third diode D3 and fourth diode D4, fifth diode D5 and sixth diode D6, seventh diode D7 and eighth diode D8, ninth diode D9 and tenth diode D10, and eleventh diode D11 and twelfth diode D12.

Further, in this embodiment, the three-phase AC-DC bidirectional conversion circuit 10 further includes an EMI filter circuit 13, the EMI filter circuit 13 includes a first capacitor C1, a second capacitor C2 and a third capacitor C3, and the first capacitor C1, the second capacitor C2 and the third capacitor C3 are connected in parallel between the first external side of the three-phase AC-DC bidirectional conversion circuit 10 and the midpoint of the output capacitor circuit. Based on the above design, the added EMI filter circuit 13 provides a bypass path for common-mode noise in the entire three-phase AC-DC bidirectional conversion circuit 10, significantly reducing common-mode noise. This helps suppress electromagnetic interference and enhances the reliability of the circuit.

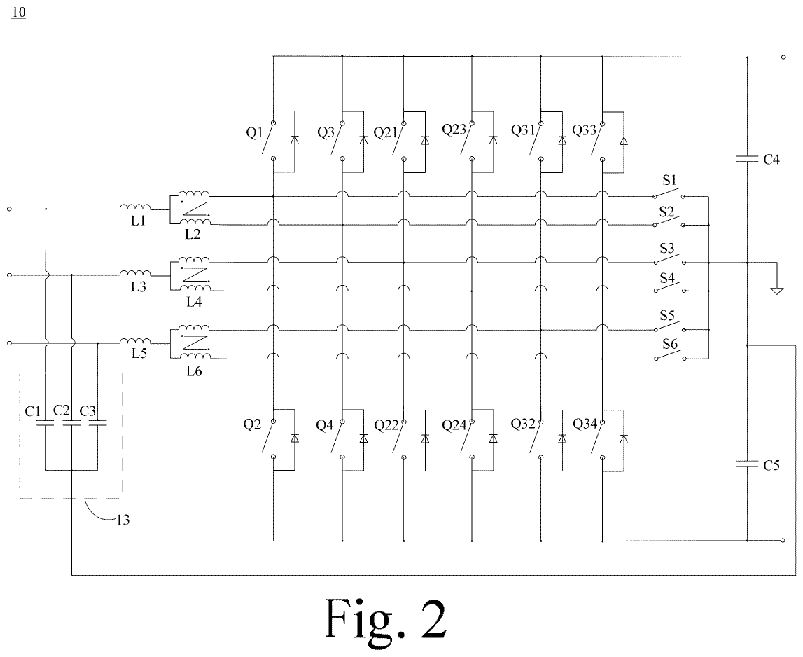

Refer to FIG. 2, which is a circuit diagram of a second embodiment of a three-phase AC-DC bidirectional conversion circuit 10 provided by the present application. This embodiment differs from the first embodiment in that the specific structure of the switch circuit in the boost circuit is different, while the remaining structures are similar or the same. In this embodiment, the switch circuit includes four switch tubes, a first bidirectional switch and a second bidirectional switch, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to the first bidirectional switch and the second bidirectional switch, the other ends of the first bidirectional switch and the second bidirectional switch are both connected to the output capacitor circuit, and midpoints of the two bridge arms are respectively connected to a connection node between the self-coupling inductor and the first bidirectional switch and a connection node between the self-coupling inductor and the second bidirectional switch. This embodiment can also achieve good circuit performance.

Specifically, in this embodiment, the switch circuit in the first boost circuit includes a first switch tube Q1, a second switch tube Q2, a third switch tube Q3, a fourth switch tube Q4, a first bidirectional switch S1, and a second bidirectional switch S2. A midpoint of a bridge arm formed by the series connection of the first switch tube Q1 and the second switch tube Q2 is connected to a connection node between the first bidirectional switch S1 and a non-dotted terminal of a primary winding of the self-coupling inductor L2. A midpoint of a bridge arm formed by the series connection of the third switch tube Q3 and the fourth switch tube Q4 is connected to a connection node between the second bidirectional switch S2 and a dotted terminal of a secondary winding of the self-coupling inductor L2. Both the first bidirectional switch S1 and the second bidirectional switch S2 are connected to a midpoint of the output capacitor circuit. The switch circuit in the second boost circuit includes a first switch tube Q21, a second switch tube Q22, a third switch tube Q23, a fourth switch tube Q24, a first bidirectional switch S3, and a second bidirectional switch S4. A midpoint of a bridge arm formed by the series connection of the first switch tube Q21 and the second switch tube Q22 is connected to a connection node between the first bidirectional switch S3 and a non-dotted terminal of a primary winding of the self-coupling inductor LA. A midpoint of a bridge arm formed by the series connection of the third switch tube Q23 and the fourth switch tube Q24 is connected to a connection node between the second bidirectional switch S4 and a dotted terminal of a secondary winding of the self-coupling inductor L4. Both the first bidirectional switch S3 and the second bidirectional switch S4 are connected to a midpoint of the output capacitor circuit. The switch circuit in the third boost circuit includes a first switch tube Q31, a second switch tube Q32, a third switch tube Q33, a fourth switch tube Q34, a first bidirectional switch S5, and a second bidirectional switch S6. A midpoint of a bridge arm formed by the series connection of the first switch tube Q31 and the second switch tube Q32 is connected to a connection node between the first bidirectional switch S5 and a non-dotted terminal of a primary winding of the self-coupling inductor L6. A midpoint of a bridge arm formed by the series connection of the third switch tube Q33 and the fourth switch tube Q34 is connected to a connection node between the second bidirectional switch S6 and a dotted terminal of a secondary winding of the self-coupling inductor L6. Both the first bidirectional switch S5 and the second bidirectional switch S6 are connected to a midpoint of the output capacitor circuit.

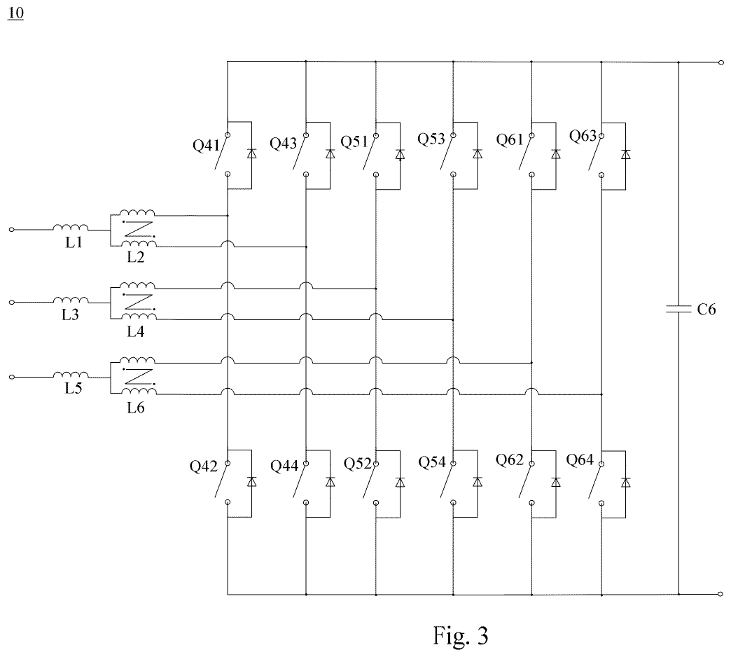

Refer to FIG. 3, which is a circuit diagram of a third embodiment of a three-phase AC-DC bidirectional conversion circuit 10 provided by the present application. This embodiment differs from the first embodiment in that the specific structures of the switch circuit and the output capacitor circuit in the boost circuit are different, and the EMI filter circuit is not included in this embodiment. The remaining structures are similar or the same. In this embodiment, the switch circuit includes four switch tubes, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, and a non-dotted terminal of the primary winding of the self-coupling inductor and a dotted terminal of the secondary winding of the self-coupling inductor are respectively connected to midpoints of the two bridge arms; and the output capacitor circuit includes a sixth capacitor C6, and the sixth capacitor C6 is connected in parallel with the bridge arms of the three boost circuits.

Specifically, in this embodiment, the switch circuit in the first boost circuit includes a first switch tube Q41, a second switch tube Q42, a third switch tube Q43, and a fourth switch tube Q44. A midpoint of a bridge arm formed by the series connection of the first switch tube Q41 and the second switch tube Q42 is connected to a non-dotted terminal of a primary winding of the self-coupling inductor L2. A midpoint of a bridge arm formed by the series connection of the third switch tube Q43 and the fourth switch tube Q44 is connected to a dotted terminal of a secondary winding of the self-coupling inductor L2. The switch circuit in the second boost circuit includes a first switch tube Q51, a second switch tube Q52, a third switch tube Q53, and a fourth switch tube Q54. A midpoint of a bridge arm formed by the series connection of the first switch tube Q51 and the second switch tube Q52 is connected to a non-dotted terminal of a primary winding of the self-coupling inductor L4. A midpoint of a bridge arm formed by the series connection of the third switch tube Q53 and the fourth switch tube Q54 is connected to a dotted terminal of a secondary winding of the self-coupling inductor LA. The switch circuit in the third boost circuit includes a first switch tube Q61, a second switch tube Q62, a third switch tube Q63, and a fourth switch tube Q64. A midpoint of a bridge arm formed by the series connection of the first switch tube Q61 and the second switch tube Q62 is connected to a non-dotted terminal of a primary winding of the self-coupling inductor L6. A midpoint of a bridge arm formed by the series connection of the third switch tube Q63 and the fourth switch tube Q64 is connected to a dotted terminal of a secondary winding of the self-coupling inductor L6.

To summarize, the switch tube in the three-phase AC-DC bidirectional conversion circuit provided by the present application can achieve bidirectional energy flow. The three boost circuits employ three-phase interleaving technology, with the three-phase input and output currents differing by 120°. The input and output current fluctuations of the three-phase boost circuits are complementary, resulting in small input and output voltage and current ripples in the three-phase AC-DC bidirectional conversion circuit, thereby achieving excellent circuit performance. Each boost circuit is formed by parallel connection of two step-up circuits with the same frequency but a 180° phase difference. A boost inductor employs a three-inductor structure consisting of a first inductor and self-coupling inductors. Through an interleaved design, the switching frequency can be increased, enabling low-cost filtering and reducing control complexity. At the same time, it can further reduce input and output voltage and current ripples. Additionally, the interleaved design enables the two branches containing the self-coupling inductors to achieve current sharing during both forward and reverse energy flow, preventing uneven heating of branch components and further improving the working performance of the circuit.

The above description merely presents preferred embodiments of the present application, and it is not intended to limit this application in any form. Those skilled in the art can make various equivalent changes and improvements on the basis of the above-mentioned embodiments, and all equivalent changes or modifications made within the scope of the claims shall fall within the protection scope of this application.

1. A three-phase AC-DC bidirectional conversion circuit, comprising three boost circuits with the same structure and one output capacitor circuit, wherein each boost circuit comprises an inductor circuit and a switch circuit, the inductor circuit comprises a first inductor and a self-coupling inductor, the switch circuit comprises eight switch tubes and four diodes, every four switch tubes are connected in series to form a bridge arm, two bridge arms are connected in parallel and are then connected to one side of the output capacitor circuit, every two diodes are connected in series and are then connected in parallel to two switch tubes located in the middle of a bridge arm, a junction between the two diodes connected in series is connected to the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to midpoints of the bridge arms, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

2. The three-phase AC-DC bidirectional conversion circuit according to claim 1, wherein the output capacitor circuit comprises a fourth capacitor and a fifth capacitor, the fourth capacitor and the fifth capacitor are connected in series and then connected in parallel with the bridge arms of the three boost circuits, and a junction of the fourth capacitor and the fifth capacitor is a midpoint of the output capacitor circuit and is connected to the junction between two diodes connected in series.

3. The three-phase AC-DC bidirectional conversion circuit according to claim 2, wherein the three-phase AC-DC bidirectional conversion circuit further comprises an EMI filter circuit, the EMI filter circuit comprises a first capacitor, a second capacitor and a third capacitor, and the first capacitor, the second capacitor and the third capacitor are connected in parallel between the first external side of the three-phase AC-DC bidirectional conversion circuit and the midpoint of the output capacitor circuit.

4. The three-phase AC-DC bidirectional conversion circuit according to claim 1, wherein the switch tube is selected from MOSFET, IGBT, GaN tube or SiC power tube.

5. A three-phase AC-DC bidirectional conversion circuit, comprising three boost circuits with the same structure and one output capacitor circuit, wherein each boost circuit comprises an inductor circuit and a switch circuit, the inductor circuit comprises a first inductor and a self-coupling inductor, the switch circuit comprises four switch tubes, a first bidirectional switch and a second bidirectional switch, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to the first bidirectional switch and the second bidirectional switch, the other ends of the first bidirectional switch and the second bidirectional switch are both connected to the output capacitor circuit, midpoints of the two bridge arms are respectively connected to a connection node between the self-coupling inductor and the first bidirectional switch and a connection node between the self-coupling inductor and the second bidirectional switch, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

6. A three-phase AC-DC bidirectional conversion circuit, comprising three boost circuits with the same structure and one output capacitor circuit, wherein each boost circuit comprises an inductor circuit and a switch circuit, the inductor circuit comprises a first inductor and a self-coupling inductor, the switch circuit comprises four switch tubes, every two switch tubes are connected in series to form a bridge arm, two bridge arms are connected in parallel and are then connected to one side of the output capacitor circuit, a dotted terminal of a primary winding of the self-coupling inductor and a non-dotted terminal of a secondary winding of the self-coupling inductor are both connected to one end of the first inductor, a non-dotted terminal of the primary winding of the self-coupling inductor and a dotted terminal of the secondary winding of the self-coupling inductor are respectively connected to midpoints of the bridge arms, the other side of the output capacitor circuit serves as a second external side of the three-phase AC-DC bidirectional conversion circuit, and the other end of each first inductor in each of the three boost circuits serves as a first external side of the three-phase AC-DC bidirectional conversion circuit.

7. The three-phase AC-DC bidirectional conversion circuit according to claim 6, wherein the output capacitor circuit comprises a sixth capacitor, and the sixth capacitor is connected in parallel with the bridge arms of the three boost circuits.
